(19) United States
(12) Patent Application Publication
(10) Pub. No.: US 2015/0144593 A1
(43) Pub. Date: May 28, 2015

(54) APPARATUS AND METHOD FOR POLISHING AND STRENGTHENING SUBSTRATE

(71) Applicant: Samsung Display Co., Ltd., Yongin-City (KR)

(72) Inventors: Joo Woan Cho, Seongnam-si (KR); Seungho Kim, Asan-si (KR)

(21) Appl. No.: 14/302,227

(22) Filed: Jun. 11, 2014

(30) Foreign Application Priority Data
Nov. 26, 2013 (KR) 10-2013-0144705

(51) Int. Cl. B24B 17/08; C03C 15/02; B24B 1/00

(52) U.S. Cl. CPC B24B 17/08; B24B 1/00; C03C 15/02
USPC 216/53; 156/345.12

(57) ABSTRACT

An apparatus and method for polishing and strengthening a substrate are disclosed. In one aspect, the apparatus includes a table on which a substrate is placed, a powder supply portion for polishing a surface of the substrate, a substance supply portion, and an injector. The powder supply portion is placed over the table. The substance supply portion is configured to supply a substance onto the polished surface of the substrate. The injector is configured to inject the powder from the powder supply portion onto the surface of the substrate and the substance from the substance supply portion onto the polished surface of the substrate.

### CROSS-REFERENCE TO RELATED APPLICATIONS

This U.S. non-provisional patent application claims priority under 35 U.S.C. §119 of Korean Patent Application No. 10-2013-0144705, filed on Nov. 26, 2013, the entire contents of which are hereby incorporated by reference.

### BACKGROUND

1. Field

The described technology generally relates to an apparatus and method for polishing and strengthening a substrate.

2. Description of the Related Technology

Examples of a display device recently being used include a liquid crystal display (LCD) device, an electrowetting display device, and an electrophoresis display device.

A display device includes a substrate, which can be cut using a scribing machine and laser, and a water jet.

### SUMMARY OF CERTAIN INVENTIVE ASPECTS

One inventive aspect is an apparatus and method for cutting and strengthening a substrate that can simplify a manufacturing process.

Another aspect is an apparatus for cutting and strengthening a substrate, the apparatus comprising a table on which a substrate is placed; a powder supply part for polishing which is disposed on the table and comprises a powder for polishing; a substance supply part for strengthening a cutting plane which is disposed on the table and comprises a substance for strengthening a cutting plane; and an injection part injecting the powder for polishing supplied from the powder supply part for polishing and the substance for strengthening a cutting plane supplied from the substance supply part for strengthening a cutting plane onto the substrate.

Another aspect is a method of cutting and strengthening a substrate, the method comprising disposing a substrate on a table; forming a mixed liquid by mixing a powder for polishing cutting the substrate and a substance for strengthening a cutting plane of the substrate; and injecting the mixed liquid onto the substrate to cut the substrate and strengthen a cutting plane of the substrate at the same time.

Another aspect is an apparatus for polishing and strengthening a substrate. The apparatus comprises a table on which a substrate is placed, a powder supply portion, a substance supply portion, and an injector. The powder supply portion is configured to supply a powder for polishing a surface of the substrate and positioned above the table. The substance supply portion is configured to supply a substance onto the polished surface of the substrate. The injector is configured to inject the powder from the powder supply portion onto the surface of the substrate and the substance from the substance supply portion onto the polished surface of the substrate

The above apparatus further comprises a mixer configured to mix the powder and the substance to form a mixed liquid (or mixture) and supply the mixture to the injector. In the above apparatus, the injector further comprises a mixed liquid injection nozzle (or mixture injection nozzle) configured to inject the mixture onto the surface of the substrate. In the above apparatus, the injector is configured to inject the mixture onto the surface of the substrate so as to substantially simultaneously polish and strengthen the surface of the substrate.

In the above apparatus, the injector further comprises a powder injection nozzle configured to inject the powder onto the surface of the substrate and a substance injection nozzle configured to inject the substance onto the polished surface of the substrate. In the above apparatus, the table is configured to move in a direction substantially parallel to one side of the substrate, and wherein the powder injection nozzle and the substance injection nozzle are sequentially placed in a direction substantially parallel to the direction.

In the above apparatus, the polished surface comprises a cut surface. In the above apparatus, the substance supply portion is configured to strengthen the cut surface. In the above apparatus, the substrate is a glass substrate. In the above apparatus, the powder is formed of at least one of diamond, CeO₂ and Al₂O₃. In the above apparatus, the powder has about 400 grits to about1500 grits. In the above apparatus, the substance comprises at least one of fluoric acid and hydrochloric acid. In the above apparatus, the substance has a temperature of about 20° C. to about 150° C. In the above apparatus, further comprises a heater configured to heat the substance. In the above apparatus, the injector has an injection pressure of about 40,000 psi to about 100,000 psi.

Another aspect is a method of polishing and strengthening a substrate. The method comprises placing a substrate on a table and providing a power configured to polish a surface of the substrate. The method further comprises providing a substance configured to strengthen the polished surface of the substrate, mixing the powder and the substance to form a mixture and injecting the mixture onto the substrate to substantially simultaneously polish and strengthen the surface of the substrate.

The above method further comprises moving the table in a direction substantially parallel to one side of the substrate. The above method further comprises heating the substance to a temperature of about 20° C. to about 150° C. In the above method, the injecting is performed under an injection pressure of about 40,000 psi to about 100,000 psi.

Another aspect is an apparatus for polishing and strengthening a substrate. The apparatus comprises a powder supply portion and a substance portion. The powder supply portion is configured to supply a powder for polishing a surface of the substrate. The substance supply portion is configured to supply a substance onto the polished surface of the substrate, wherein the powder supply portion and the substance supply portion are configured to substantially simultaneously supply the powder and the substance onto the surface of the substrate.

The above apparatus further comprises a mixer configured to mix the powder and the substance to form a mixture and an injector configured to inject the mixture onto the surface of the substrate. The above apparatus further comprises a heater configured to heat the substance to a temperature of about 20° C. to about 150° C.

### BRIEF DESCRIPTION OF THE DRAWINGS

Embodiments of the described technology will be described below in more detail with reference to the accompanying drawings. The embodiments of the described technology may, however, be embodied in different forms and should not be constructed as limited to the embodiments set forth herein. Rather, these embodiments are provided so that this disclosure will be thorough and complete, and will fully convey the scope of the described technology to those skilled in the art Like numbers refer to like elements throughout.

FIG. 1 is a cross sectional view of an apparatus for polishing and strengthening a substrate in accordance with an embodiment.

FIG. 2 is a cross sectional view of an apparatus for polishing and strengthening a substrate in accordance with another embodiment.

FIG. 3 is a flow chart illustrating a method of polishing and strengthening a substrate in accordance with an embodiment.

### DETAILED DESCRIPTION OF CERTAIN INVENTIVE EMBODIMENTS

When a substrate is cut using a scribing machine and laser, the quality of the substrate degrades due to the heat and pressure that are applied while cutting. If a strengthened substrate is cut using a water jet, the stress balance of the strengthened substrate is lost and thereby the substrate does not have a uniform strength. This can result in a corner portion of the substrate being easily chipped. Since cutting and strengthening a substrate cannot be performed at the same time using a scribing machine, a laser, and a water jet, the process has inherent inefficiency.

Embodiments of described technology will be described more fully hereinafter with reference to the accompanying drawings, in which embodiments of the described technology are shown. This described technology may, however, be embodied in many different forms and should not be construed as limited to the embodiments set forth herein. Rather, these embodiments are provided so that this disclosure will be thorough and complete, and will fully convey the scope of the described technology to those skilled in the art. In the drawings, the size and relative sizes of layers and regions may be exaggerated for clarity. Like numbers refer to like elements throughout.

In the drawings, the thickness of layers and regions are exaggerated for clarity. It will also be understood that when an element such as a layer, region or substrate is referred to as being “on” or “onto” another element, it may lie directly on the other element or intervening elements or layers may also be present.

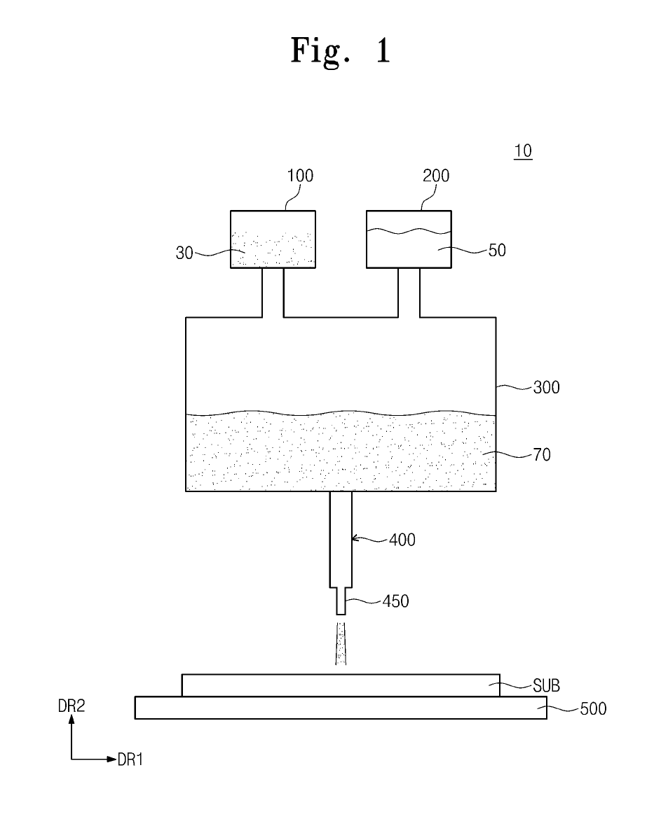

FIG. 1 is a cross sectional view of an apparatus 10 for cutting (or polishing) and strengthening a substrate SUB in accordance with an embodiment.

Referring to FIG. 1, the apparatus 10 includes a table 500, a powder supply part or powder supply portion 100, a substance supply part or substance supply portion 200 and an injection part or injector 400.

The substrate SUB is placed on the table 500. The substrate SUB may be a glass substrate, and the glass substrate may be a regular glass or a strengthened glass.

The powder supply part 100 is placed on the table 500 (for example, in a DR2 direction) and includes a powder 30 for polishing. The substance supply part 200 is placed over the table 500 (for example, in a DR2 direction), is spaced apart from the powder supply part 100, and includes a substance 50 for strengthening a cutting plane.

The powder supply part 100 and the substance supply part 200 can directly supply the powder 30 and the substance 50 respectively to the injection part 400 and can supply them to a mixing part (or mixer) 300.

The powder 30 is injected onto the substrate SUB. The powder 30 can include microscale particles. The substrate SUB can be finely worn down at a place where the substrate SUB and the powder 30 are in contact with each other. The powder 30 can include at least one of diamond, CeO₂ or Al₂O₃. The powder 30 can have about 400 grits to about 1500 grits. The unit grit means the number of particles that exist per inch. When the grit of the powder 30 is less than about 400, it can be difficult to cut the substrate SUB since the quantity of the powder 30 is low. When the grit of the powder 30 is greater than about 1500, the quantity of the powder 30 is so large that damage can occur at a place where the substrate SUB and the powder 30 are not in contact with each other. However, depending on embodiments, the grit can be less than about 400 or greater than about 1500.

The substance 50 chemically strengthens a surface of the substrate SUB cut by the powder 30. The substance 50 can be liquid. The substance 50 can include fluoric acid and hydrochloric acid. In some embodiments, if the substrate SUB is a glass substrate, and since the glass substrate has alkalinity, a substance having acidity is used.

In some embodiments, the substance 50 has a temperature of about 20° C. to about 150° C. The apparatus 10 can increase a substrate cutting speed by using the substance 50 at a high temperature. When the temperature of the substance 50 is lower than about 20° C., since activation energy is small, the substrate cutting speed can be low. When the temperature of the substance 50 exceeds about 150° C., since the substance 50 evaporates, it can be difficult to strengthen a cutting plane of a substrate. However, depending on embodiments, the temperature of the substance 50 can be less than about 20° C. or greater than about 150° C.

The apparatus 10 can further include a heating part or heater (not shown) heating the substance 50. The substance 50 can be heated to a temperature of about 20° C. to about 150° C. through the heating part. The heating part can include at least one of an electronic heater, a high frequency heater, an infrared heater or a gas heater. The heating part can be connected to at least one of the powder supply part 100, the substance supply part 200 or the mixing part 300. The heating part can heat not only the substance 50 but also the powder 30.

The apparatus 10 can further include the mixing part 300. The mixing part 300 mixes the powder 30 supplied by the powder supply part 100 and the substance 50 supplied by the substance supply part 200 to form a mixed liquid or mixture 70. In this case, the powder 30 does not dissolve in the substance 50. The mixing part 300 can include a mixer (not shown) to effectively mix the powder 30 and the substance 50. The mixed liquid 70 is supplied to the injection part 400.

The injection part 400 injects the powder 30 the mixed liquid 70 onto the substrate SUB. The powder 30 can cut the substrate SUB and the substance 50 can strengthen a cutting plane of the substrate SUB.

The injection part 400 can have an injection pressure of about 40,000 psi to about 100,000 psi. The injection part 400 can inject the powder 30 and the substance 50 at a high pressure to cut the substrate SUB without a cutting machine such as a laser device. When the injection pressure of the injection part 400 is lower than about 40,000 psi, since the injection pressure is low, it can be difficult to cut the substrate SUB. When the injection pressure of the injection part 400 is higher than about 100,000 psi, since the injection pressure is high, the substrate SUB can be damaged. However, depending on embodiments, the injection pressure of the injection part 400 can be less than about 40,000 psi or greater than about 100,000 psi.

The injection part 400 can include a mixed liquid injection nozzle or mixture injection nozzle 450 injecting the mixed liquid 70 supplied by the mixing part 300. By injecting the mixed liquid 70 onto the substrate SUB, the substrate SUB can be cut and strengthened at a place where the substrate SUB and the mixed liquid 70 are in contact with each other. Using this method, a cutting process and a strengthening process of the substrate SUB are combined into a combined process and thereby production time can be reduced. In some embodiments, the combined process is simpler than the two processes performed separately, and thus cutting various types of substrates SUB can be more efficiently performed than other methods mentioned above.

The table 500 can move in a first direction (e.g., a DR1 direction of FIG. 1) substantially parallel to one side of the substrate SUB. The combined process can be continuously performed at multiple locations of the substrate SUB while moving the table 500. The combined process can also be continuously performed on a plurality of substrates SUB placed on the table 500.

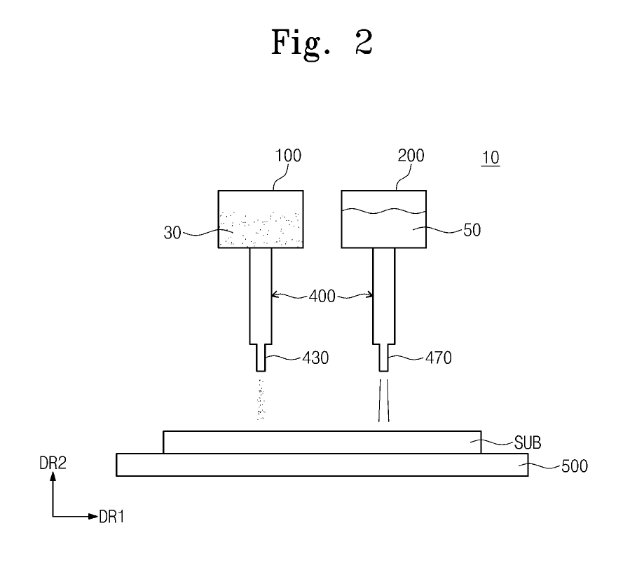

FIG. 2 is a cross sectional view of the apparatus 10 for cutting and strengthening a substrate in accordance with another embodiment. Hereinafter, a difference between the two apparatuses of FIGS. 1 and 2 is mainly described.

The injection part 400 includes a powder injection nozzle 430 injecting the powder 30 and a substance injection nozzle 470 injecting the substance 50.

The table 500 can move in a first direction (e.g., a DR1 direction of FIG. 2) substantially parallel to the substrate SUB. The powder injection nozzle 430 and the substance injection nozzle 470 can be sequentially injected on the substrate SUB in the first direction.

When the table 500 moves in the first direction, the substrate SUB placed on the table 500 is cut (or polished) by the powder 30 injected from the powder injection nozzle 430. Furthermore, a cutting plane of the substrate SUB is strengthened by the substance 50 injected from the substance injection nozzle 470. This combined method can simplify the cutting process and the strengthening process of the substrate SUB.

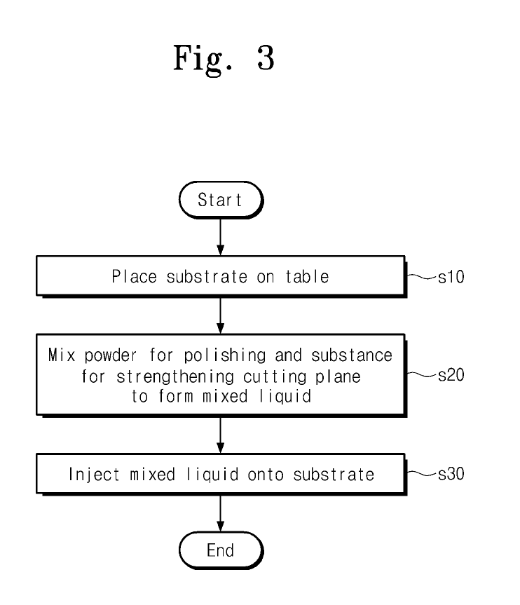

FIG. 3 is a flow chart illustrating a method of cutting and strengthening a substrate in accordance with an embodiment. Depending on the embodiment, additional states can be added, others removed, or the order of the states changed in FIG. 3.

Referring to FIG. 3, the substrate SUB is placed on the table 500 (s10). In some embodiments, as shown in FIG. 1, the substrate SUB is placed within the table 500. For example, the center of the substrate SUB can be substantially aligned with the center of the table 500. The length or width of the substrate SUB can be substantially equal to or less than that of the table 500.

The powder 30 and the substance 50 are mixed to form the mixed liquid 70 (s20). As discussed above, in forming the mixed liquid 70, the mixer 300 can be used to effectively mix the powder 30 and the substance 50. The mixed liquid 70 can be supplied to the injection part 400 to be injected onto the substrate SUB.

The mixed liquid 70 is injected onto the substrate SUB to cut and strengthen the substrate SUB substantially simultaneously (s30). The substrate SUB can be cut and strengthened by the mixed liquid 70 substantially at the same time.

The method can further include heating the substance 50, for example, at a temperature of about 20° C. to about 150° C.

The substrate SUB cut and chemically strengthened by the above method can go through a cleaning process and a dry process. The substrate SUB, which has gone through a cleaning process and a dry process, can substantially remove scrap in an unloading process and then it can be released as finished goods.

Although a few embodiments of the described technology have been shown and described, it will be appreciated by those skilled in the art that changes can be made in these embodiments without departing from the principles and spirit of the described technology, the scope of which is defined in the appended claims and their equivalents. Therefore, the above-disclosed subject matter is to be considered illustrative, and not restrictive.

What is claimed is:

1. An apparatus for polishing and strengthening a substrate, comprising:
a table on which a substrate is placed;
a powder supply portion configured to supply a powder for polishing a surface of the substrate and positioned above the table;
a substance supply portion configured to supply a substance onto the polished surface of the substrate; and
an injector configured to inject i) the powder from the powder supply portion onto the surface of the substrate and ii) the substance from the substance supply portion onto the polished surface of the substrate.

2. The apparatus of claim 1, further comprising a mixer configured to mix the powder and the substance to form a mixture and supply the mixture to the injector.

3. The apparatus of claim 2, wherein the injector further comprises a mixture injection nozzle configured to inject the mixture onto the surface of the substrate.

4. The apparatus of claim 2, wherein the injector is configured to inject the mixture onto the surface of the substrate so as to substantially simultaneously polish and strengthen the surface of the substrate.

5. The apparatus of claim 1, wherein the injector comprises a powder injection nozzle configured to inject the powder onto the surface of the substrate and a substance injection nozzle configured to inject the substance onto the polished surface of the substrate.

6. The apparatus of claim 5, wherein the table is configured to move in a direction substantially parallel to one side of the substrate, and wherein the powder injection nozzle and the substance injection nozzle are sequentially placed in a direction substantially parallel to the direction.

7. The apparatus of claim 1, wherein the polished surface comprises a cut surface.

8. The apparatus of claim 7, wherein the substance supply portion is configured to strengthen the cut surface.

9. The apparatus of claim 1, wherein the substrate is a glass substrate.

10. The apparatus of claim 1, wherein the powder is formed of at least one of diamond, CeO₂ and Al₂O₃.

11. The apparatus of claim 1, wherein the powder has about 400 grits to about 1500 grits.

12. The apparatus of claim 1, wherein the substance comprises at least one of fluoric acid and hydrochloric acid.

13. The apparatus of claim 1, wherein the substance has a temperature of about 20° C. to about 150° C.

14. The apparatus of claim 1, further comprising a heater configured to heat the substance.

15. The apparatus of claim 1, wherein the injector has an injection pressure of about 40,000 psi to about 100,000 psi.

16. A method of polishing and strengthening a substrate, comprising:
placing a substrate on a table;
providing a power configured to polish a surface of the substrate;
providing a substance configured to strengthen the polished surface of the substrate;
mixing the powder and the substance to form a mixture; and
injecting the mixture onto the substrate to substantially simultaneously polish and strengthen the surface of the substrate.

17. The method of claim 16, further comprising moving the table in a direction substantially parallel to one side of the substrate.

18. The method of claim 16, further comprising heating the substance to a temperature of about 20° C. to about 150° C.

19. The method of claim 16, wherein the injecting is performed under an injection pressure of about 40,000 psi to about 100,000 psi.

20. An apparatus for polishing and strengthening a substrate, comprising:
a powder supply portion configured to supply a powder for polishing a surface of the substrate; and
a substance supply portion configured to supply a substance onto the polished surface of the substrate, wherein the powder supply portion and the substance supply portion are configured to substantially simultaneously supply the powder and the substance onto the surface of the substrate.

21. The apparatus of claim 20, further comprising:
a mixer configured to mix the powder and the substance to form a mixture; and
an injector configured to inject the mixture onto the surface of the substrate.

22. The apparatus of claim 21, further comprising a heater configured to heat the substance to a temperature of about 20° C. to about 150° C.
